(19) United States
(12) Patent Application Publication
(10) Pub. No.: US 2026/0046629 A1
(43) Pub. Date: Feb. 12, 2026

(54) MANAGEMENT OF POWER-RESTRICTED RADIO RESOURCE CONFIGURATIONS

(71) Applicant: T-MOBILE INNOVATIONS LLC, Overland Park, KS (US)

(72) Inventor: William Martin SHVODIAN, McLean, VA (US)

(21) Appl. No.: 19/293,792

(22) Filed: Aug. 7, 2025

Related U.S. Application Data
(60) Provisional application No. 63/680,576, filed on Aug. 7, 2024.

(51) Int. Cl. H04W 16/02; H04L 41/5009; H04W 52/36; H04W 72/044; H04W 84/06

(52) U.S. Cl. CPC H04W 16/02; H04L 41/5009; H04W 52/367; H04W 72/044; H04W 84/06

(57) ABSTRACT

Embodiments of the present disclosure are directed to improving the management of user equipment (UE) uplink transmission power. If a candidate radio resource allocation meets a parameter of a standard-dictated high A-MPR or if it comprises resource blocks that are within a predetermined threshold distance of an allocated spectrum bandwidth edge, then that candidate radio resource allocation may not be assigned to the UE. Avoiding power-restricted radio allocations may be particularly effective for UEs at or near a cell edge, in challenging radio conditions, or when communicating with a satellite RAN—all of which typically require UEs to maximize their transmission power

### CROSS-REFERENCE TO RELATED APPLICATIONS

This application claims the benefit of Provisional U.S. Patent Application No. 63/680,576 filed on Aug. 7, 2024, the entirety of which is incorporated herein by reference.

### SUMMARY

The present disclosure is directed to managing the allocation of power-restricted radio resource allocations, substantially as shown and/or described in connection with at least one of the Figures, and as set forth more completely in the claims.

According to various aspects of the technology, some radio resource allocations will not be permitted for use by user equipment (UEs) in the uplink due to the proximity of the allocation to an allocated spectrum bandwidth edge. Traditionally regulated by maximum power reduction (MPR) and additional MPR (A-MPR), there are some use cases—such as when connected to a satellite or far-field terrestrial base station—wherein a UE is unlikely to successfully connect in a power-constrained condition imposed by A-MPR. By using high A-MPR values or threshold proximity to a band edge as triggers for barring radio allocations, user experience will improve, and the amount of time needed for a UE to establish and maintain an effective connection with a base station when the candidate radio resources meet one or more of the trigger conditions will be reduced compared to the UE reducing power by applying A-MPR.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates a computing device for use with the present disclosure;

FIG. 2 illustrates network environments in which implementations of the present disclosure may be employed;

FIGS. 3A-3B illustrate additional maximum power reduction tables for use with the present disclosure;

FIG. 4 illustrates a portion of a radio frequency spectrum for use with the present disclosure;

FIG. 5 depicts a flow diagram of a method in accordance with embodiments described herein; and

FIG. 6 illustrates a flow diagram of a method in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies suitable for use with the present disclosure include but are not limited to 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, maximum transmission power, MPR (Maximum Power Reduction), and A-MPR (Additional Maximum Power Reduction) are features of modern wireless communication networks that are used to manage power levels in order to ensure regulatory compliance and optimize network performance. Maximum transmission power sets the highest power level at which a User Equipment (UE) can transmit, ensuring that devices operate within safe and regulated limits to prevent interference with other communications and ensure user safety. MPR is used to reduce the maximum transmission power under certain conditions to avoid interference with adjacent channels, typically near the band edges. A-MPR is an additional power reduction which is greater than or equal to MPR can be applied to further control emissions and ensure compliance with stricter regulatory requirements, especially in scenarios with wide bandwidth usage or high modulation schemes. While MPR is a standard requirement for managing interference for any band, A-MPR is used in more specific, demanding situations to provide an extra layer of emission control.

Conventionally, radio access networks do not strictly avoid allocating resources subject to high A-MPR. Allocating resources that are subject to high A-MPR can lead to reduced data rates and higher resource consumption for the same level of service. For example, more Resource Blocks (RBs) might be needed to achieve the same throughput, impacting spectral efficiency. Accordingly, some RAN nodes may consider A-MPR in radio resource allocation, biasing high A-MPR assignments to non-critical data, sessions with less sensitive quality of service requirements, or lower priority data/connections or UEs with good signal quality and/or plenty of power overhead.

Unlike conventional solutions, the present disclosure is directed to improving the management of UE uplink transmission power. If a candidate radio resource allocation meets a parameter of a standard-dictated high A-MPR or if it comprises resource blocks that are within a predetermined threshold distance of an allocated spectrum bandwidth edge, then that candidate radio resource allocation may not be assigned to the UE. In other aspects, if the candidate radio resource allocation is assigned to the UE, then the UE may expeditiously attempt to use the power-restricted assignment and inform the RAN, prompting it for a new assignment. Avoiding power-restricted radio allocations may be particularly effective for UEs at or near a cell edge, in challenging radio conditions, or when communicating with a satellite RAN—all of which typically require UEs to maximize their transmission power.

Accordingly, a first aspect of the present disclosure is directed to a system for managing uplink transmission power in a wireless telecommunication environment. The system comprises a base station configured to wirelessly communicate with a coverage area. The system further comprises one or more computer processing components configured to perform a series of operations. Said operations comprise allocating a second radio resource to a UE instead of the first radio resource allocation based at least in part on a second determination that the one or more trigger conditions are not associated with the second radio resource allocation.

A second aspect of the present disclosure is directed to a method for uplink power control. The method comprises receiving a first radio resource allocation from a radio access network (RAN), wherein the first radio resource allocation comprises an additional maximum power reduction (A-MPR) value greater than a predetermined threshold or within a predetermined threshold of an allocated spectrum bandwidth edge. The method further comprises communicating one or more uplink signals using the first radio resource allocation, wherein the one or more uplink signals are communicated using a transmission power having a spurious emission level less than or equal to a predetermined level, the transmission power being within a range defined by the A-MPR of a maximum class-based transmission power minus a maximum power reduction (MPR) value associated with the first radio resource allocation. The method further comprises determining that the transmission power is insufficient for establishing or maintaining a connection with the RAN having one or more key performance indicator values greater than a predetermined threshold. The method further comprises receiving a second radio resource allocation, wherein the second radio resource allocation has a smaller A-MPR value than the first radio resource allocation.

Another aspect of the present disclosure is directed to a method for radio resource allocation. The method comprises identifying a candidate radio resource allocation for a user equipment (UE) to use in an uplink communication session. The method further comprises determining that the candidate radio resource allocation is power limited on the basis that the candidate radio resource allocation has one or more parameters that are associated with a trigger condition, or a starting/final resource block being with a predetermined threshold frequency distance of an allocated spectrum bandwidth edge. The method further comprises, based on said determination, assigning a second radio resource allocation to the UE instead of the candidate radio resource allocation, the second radio resource allocation not having the one or more parameters that are associated with the trigger condition.

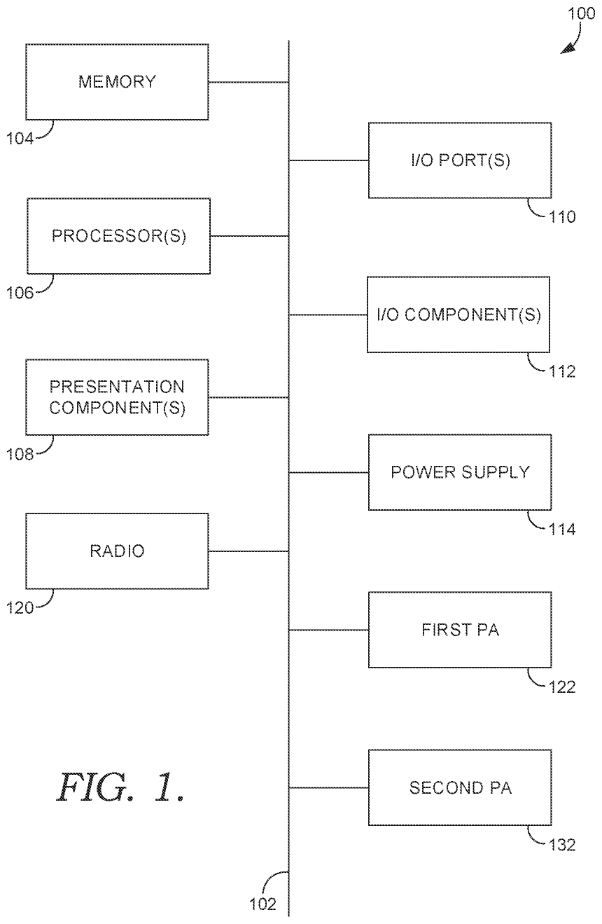

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device. The computing device 100 may take the form of a wireless access device that acts as a more localized and consolidated access point that provides end user wireless devices access to a broader network; examples of wireless access devices include fixed wireless access (FWA) devices and mobile hotspots. The computing device 100 may take the form of a mobile device, used herein to refer to categories of often-portable devices that utilize a wireless connection to a broader network and are typically configured for direct human interaction and personal computing tasks; examples of mobile devices include smartphones, tablets, computers (e.g., laptops and PCs), wearable devices (e.g., smartwatches, fitness tracker), electronic readers (i.e., an e-book reader or digital book reader), portable media player, handheld GPS/location device, digital camera, gaming console, and digital voice recorders. The computing device may take the form of a connected vehicle that integrates advanced communication and computing technologies to interact with other devices and networks, encompassing vehicle to vehicle (V2V) communications, vehicle to infrastructure (V2I) communications, and/or vehicle to everything (V2X) communications, and that utilizes a wireless connection to support telematics, infotainment systems, over the air updates, vehicle health monitoring, and/or enhanced navigation; examples of connected vehicles include automotive, locomotive, airborne, and cargo (e.g., train car, semi-trailer) systems. The computing device 100 may take the form of an Internet of Things (IoT) device, a physical object embedded with sensors, software, or other technologies that enable them to collect, exchange, and act on data using an internet connection, which allows them to perform automated, decision-making or, other content-provision tasks; examples of IoT devices include smart home devices (e.g., smart thermostats, smart lights, power supply/management systems, and smart security systems), connected appliances (e.g., smart refrigerators), health monitoring devices (e.g., blood pressure monitor, glucose monitor), industrial devices (e.g., smart sensors, predictive maintenance systems), and agricultural devices (e.g., soil, environmental, or growth sensors).

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and a second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, 802.11, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VoIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

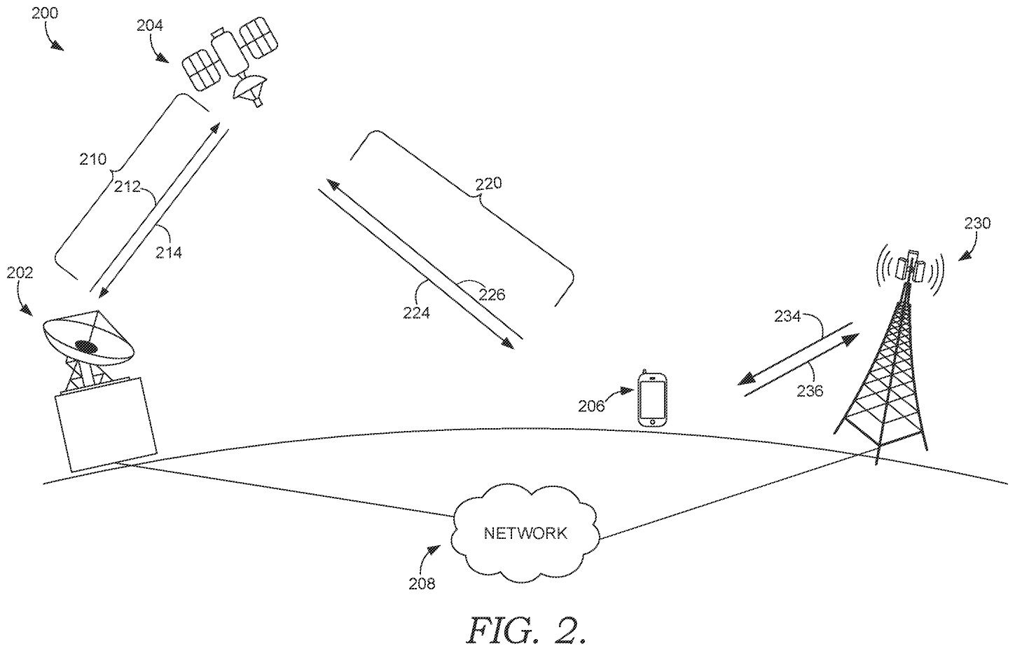

Turning now to FIG. 2, an exemplary network environment is illustrated in which implementations of the present disclosure may be employed. Such a network environment is illustrated and designated generally as network environment 200. At a high level the network environment 200 comprises a radio access network (RAN), a UE 206, and a network 208. In aspects of the present disclosure the RAN may take the form of a satellite RAN, which comprises at least a gateway 202 and a satellite 204. In other aspects, the RAN may comprise a terrestrial network comprising at least the terrestrial base station 230. Though both the satellite RAN and terrestrial RAN aspects are illustrated in the network environment 200, it is expressly conceived that the present disclosure may be suitable for use in an environment containing only one of the satellite RAN or the terrestrial RAN. Further, though the composition of network environment 200 illustrates objects in the singular, it should be understood that more than one of each component is expressly conceived as being within the bounds of the present disclosure; for example, the network environment 200 may comprise multiple gateways, multiple distinct networks, multiple UEs, multiple satellites that communicate with a single gateway or multiple gateways, multiple satellites that may have inter-satellite links, multiple terrestrial base stations, and the like. Though certain objects of network environment 200 are illustrated in a certain form, it should also be understood that they may take other forms; for example, even though the UE 206 is illustrated as a cellular phone, a UE suitable for implementations with the present disclosure may be any computing device having any one or more aspects described with respect to FIG. 1, and even though the terrestrial base station 230 is illustrated as a macro cell mounted on a tower, a terrestrial base station suitable for use with the present disclosure is any terrestrial station configured to transmit signals to and receive signals from the UE 206 (e.g., a small cell, pico cell, relay, and the like).

In aspects where the RAN of the network environment 200 is a satellite RAN, the gateway 202 may be said to be communicatively connected to the network 208 and the satellite 204. The gateway 202 may be connected to the network 208 via one or more wireless or wired connections and is connected to the satellite 204 via a feeder link 210. The gateway 202 may take the form of a device or a system of components configured to communicate with the UE 206 via the satellite 204 and to provide an interface between the network 208 and the satellite 204. Generally, the gateway 202 utilizes one or more antennas to transmit signals to the satellite 204 via a forward uplink 212 and to receive signals from the satellite 204 via a return downlink 214. The gateway 202 may communicate with a plurality of satellites, including the satellite 204. The network 208 comprises any one or more public or private networks, any one or more of which may be configured as a satellite network, a publicly switched telephony network (PSTN), or a cellular telecommunications network. In aspects, the network 208 may comprise a satellite network connecting a plurality of gateways (including the gateway 202) to other networks, a cellular core network (e.g., a 4G, 5G, of 6G core network, an IMS network, and the like), and a data network. In such aspects, each of the satellite network and the cellular core network may be associated with a network identifier such as a public land mobile network (PLMN), a mobile country code, a mobile network code, or the like, wherein the network identifier associated with the satellite network is the same or different than the network identifier associated with the cellular network.

When present in the network environment 200, the satellite 204 is generally configured to provide wireless communication service to the UE 206. In aspects where the satellite 204 is a bent pipe type, the satellite 204 may primarily operate by relaying communications between the gateway 202 and the UE 206. In aspects where the satellite 204 is processing or regenerative type, the satellite 204 may handle at least some signal processing, routing, switching, and resource allocation/scheduling on board, while still using a connection to the gateway 202 as a backhaul to the network 208. The satellite 204 communicates with the gateway using the feeder link 210 and communicates with the UE 206 using a user link 220. The user link 220 comprises a forward downlink 224 used to communicate signals from the satellite 204 to the UE 206 and a return uplink 226 used to communicate signals from the UE 206 to the satellite 204. The satellite 204 may communicate with the UE 206 using any wireless telecommunication protocol desired by a network operator, including but not limited to 3G, 4G, 5G, 6G, 802.11x and the like. Though shown as having a single beam providing coverage to a satellite coverage area 222, the satellite 204 may be configured to utilize a plurality of individual beams to communicate with multiple different areas at or near the same time. Similarly, though a single forward downlink 224 and a single return uplink 226 are illustrated, the UE 206 may utilize multiple downlinks and/or multiple uplinks to communicate with the satellite 204, using any one or more frequencies as desired by a satellite or network operator.

Generally, the satellite 204 is characterized by its orbit around the earth. The orbit of any particular satellite will vary by operator desire and/or intended use; for example, a satellite suitable for use with the present disclosure may be characterized by its maximum orbital altitude and/or orbital period as Low Earth Orbit (LEO), Medium Earth Orbit (MEO), and High Earth Orbit (HEO)—also referred to herein as characterizing an orbital plane. Though not rigidly defined, an LEO satellite may orbit with a maximum orbital altitude of less than approximately 1,250 miles, an MEO satellite may orbit with a maximum orbital altitude generally between 1,250 and 22,000 miles, and an HEO satellite may orbit with a maximum orbital altitude of greater than approximately 22,000 miles. In some, but not all cases, a satellite in HEO may be considered geosynchronous (i.e., geosynchronous earth orbit (GEO)) on the basis that its orbital period is approximately equal to the length of a sidereal or solar day (approximately 24 hours); generally, a satellite in geosynchronous orbit will appear to be in the same position relative to a fixed point on the surface of the earth 208 at the same time each day. A geostationary orbit is a special type of geosynchronous orbit with the Earth's equator with each of an eccentricity and inclination equal to zero. Some satellites in HEO and all that are in LEO or MEO have an orbital period that is different than the length of a sidereal/solar day and are considered to be non-geosynchronous and do not remain stationary relative to a fixed position on the surface of the Earth. As used herein, a satellite in LEO has a lower orbital plane than a satellite in MEO or HEO, an MEO satellite has a higher orbital plane than a satellite in LEO, and an HEO satellite has a higher orbital plane than a satellite in LEO or MEO.

In aspects where the RAN of the network environment 200 comprises a terrestrial wireless telecommunication network, the network environment 200 comprises one or more terrestrial base stations, represented by terrestrial base station 230. The terrestrial base station 230 is generally configured to relay communications between the network 208 and one or more UEs, such as the UE 206. The terrestrial base station 230 communicates signals to the UE 206 using a terrestrial downlink 234 and receives signals from the UE 206 using a terrestrial uplink 236. The terrestrial base station 230 may communicate with the UE 206 using any wireless telecommunication protocol desired by a network operator, including but not limited to 3G, 4G, 5G, 6G, 802.11x and the like. Though shown as having a single beam providing coverage to a terrestrial coverage area 232, the terrestrial base station 230 may be configured to utilize a plurality of individual beams to communicate with multiple different areas at or near the same time. Similarly, though a single terrestrial downlink 234 and a single terrestrial uplink 236 are illustrated, the UE 206 may utilize multiple downlinks and/or multiple uplinks to communicate with the terrestrial base station 230, using any one or more frequencies as desired by a mobile network operator.

The UE 206 of the network environment is generally configured to communicate with the satellite 204 or the base station 230 in the uplink with signals transmitted at a particular power level. Based on the class of the device, the UE 206 is typically dictated by telecommunication standards bodies or regulatory officials with a maximum transmission power; for example, power class three devices configured to operate according to the 4G and 5G standards currently have a maximum transmission power of 23 dBm. Maximum power reduction (MPR) is used to manage and reduce the maximum transmit power of UEs in specific situations to control interference and ensure compliance with network requirements and regulatory limits. Generally, reducing the maximum transmission power is done to allow UEs to meet their spectral emission mask (SEM). MPR is allowed when a UE operates in specific configurations, in order to allow UEs to conform to the SEM requirments. In addition, there are band specific requirements to prevent unwanted signals (emissions) that a transmitter (UE in this case) produces outside its assigned frequency band. This is often referred to as out-of-band emissions or spurious emissions. When these unwanted emissions fall into the frequency bands used by other UEs or base stations, they can cause interference, degrading the performance of those devices. Out of band or spurious emissions are generally restricted to a power density per MHz; for example, the power of the UE unwanted emissions into another 3GPP band downlink typically must not exceed −50 dBm when measured over a 1 MHz bandwidth. Band specific A-MPR is typically allowed when a UE operates in specific configurations or frequency bands that require lower power transmission to minimize interference with adjacent channels or other services.

In order to meet spurious emission limits, UEs are allowed to be configured to use less than their maximum transmission power under certain circumstances. The reduction in transmission power is standardized and predefined by the network to maintain optimal performance and network capacity. Additional MPR (A-MPR or AMPR) is an additional reduction. In some standards, such as 4G LTE, A-MPR added to the standard MPR to calculate the total allowed power back-off. In other standards, such as 5G NR, the total allowed reduction to UE maximum output power is the maximum of MPR and A-MPR. It is used in scenarios where even greater power reduction is necessary to mitigate interference further, especially in more challenging interference environments. A-MPR is usually applied under specific conditions such as operating in proximity to other critical services, during specific network operations, or in response to particular regulatory requirements. A-MPR values are typically specified in the standards and are designed to ensure additional protection against interference. A-MPR is usually only allowed when an associated NS signaling value is signaled, indicating that the additional emission requirements apply, though it is foreseen that A-MPR may also be permitted in the absence of NS signaling in future iterations of wireless standards. The exact amount of additional reduction can vary depending on the specific band and regulatory requirements. Just as MPR values are “up to values” sed by UEs as a baseline allowed reduction in transmission power to meet the spurious emissions mask for a given uplink radio bearer configuration, AMPR values have also conventionally been included in the standards as “up to” values, meaning that UE application of AMPR values has followed a “may implement” approach that allows the UE to reduce its power up to the specified value. Typically, the UE will be programmed at time of manufacture to use a specific amount of MPR and/or A-MPR based on the uplink configuration, in order to meet the emission limits requirements.

In an illustrative pair of examples of MPR and A-MPR, consider the UE 206 is a class three device that is wirelessly connected to the terrestrial base station 230 using LTE band 23, wherein the terrestrial uplink 236 is in a frequency range of 2000-2020 MHz and the terrestrial downlink 234 is in a frequency range of 2180-2200 MHz. In a first example, if the UE 206 is allocated 25 resource blocks with a 5 MHz channel bandwidth centered at 2015 MHz, then an MPR value of 2 dB will be allowed due to the allocation's proximity to the band edges and adjacent services; however, no A-MPR is currently permitted in the standards. If the UE 206's maximum transmission power without MPR is 23 dBm, then the UE 206's transmission power with MPR applied is 21 dBm, meaning that the UE 206 will be permitted to transmit with using 21-23 dBm. In the second example, if the UE 206 is allocated 50 resource blocks with a starting resource block of 1 and with a 15 MHz channel bandwidth centered at 2012.5 MHz, then the same 2 dB MPR will be allowed and an A-MPR value of up to 11 dB is currently permitted by the standards. With a maximum transmission power without MPR of 23 dBm, the UE 206 may transmit signals in a range of 10-23 dBm, in order to meet the spurious emissions requirements. In some aspects, UE manufacturers may pre-set UEs to use a predetermined amount of MPR and A-MPR in order to meet emission requirements; for example, two different makes/models of UEs may have different predetermined MPR/A-MPR implementations for the same band (e.g., a first UE may use the full 13 dB of MPR and A-MPR in the above example, whereas a second UE may use only 6 dB of MPR and A-MPR in similar circumstances). In other aspects, a UE may be configured to dynamically make uplink power determinations within the power range permitted by MPR/A-MPR mechanisms; for example, if the UE 206 begins transmitting signals at 11 dBm, it may increase its transmission power to 14 dBm, determine its spurious emissions are less than the threshold limit, increase again to 17 dBm, determine the spurious emissions are now greater than the threshold limit, and reduce back to a maximum transmission power of 14 dBm.

In instances where the UE 206 is on a cell edge of the terrestrial base station 230 (or in challenging radio conditions), or if the UE 206 is connected to the satellite 204, it is probabilistic that the UE 206 will not be able to establish or maintain a wireless connection using high A-MPR values due to the reduced transmission power. Accordingly, the present disclosure limits certain radio resource allocations with conventionally high A-MPR values. In a first embodiment, a base station (e.g., the terrestrial base station 230, the gateway 202 in bent-pipe satellite RANs, or the satellite 204 in switching satellite RANs) will not be allowed to schedule or assign radio resources to configurations having an A-MPR value greater than a predetermined threshold. In a second embodiment, the base station will not schedule or assign radio resources to configurations within a predetermined distance of a mobile network operator's allocated spectrum bandwidth edge. In a third embodiment, the base station may initially assign radio resources with a high A-MPR value or within the predetermined threshold distance of the allocated spectrum bandwidth edge; however, the UE may determine and communicate an indication to the base station that is in a state of uplink power limitation, upon which the base station may assign a second radio resource allocation having a smaller A-MPR allowance or further from the allocated spectrum bandwidth edge. Any of the three embodiments may be carried out based on a determination that the UE 206 is connected to a satellite RAN or based on a determination that the UE 206's connection to the terrestrial base station 230 has one or more key performance indicators below a predetermined threshold (e.g., a poor SINR, a poor RSRP, or a poor RSRQ), that indicates the UE 206 is in challenging radio conditions or is near the cell edge.

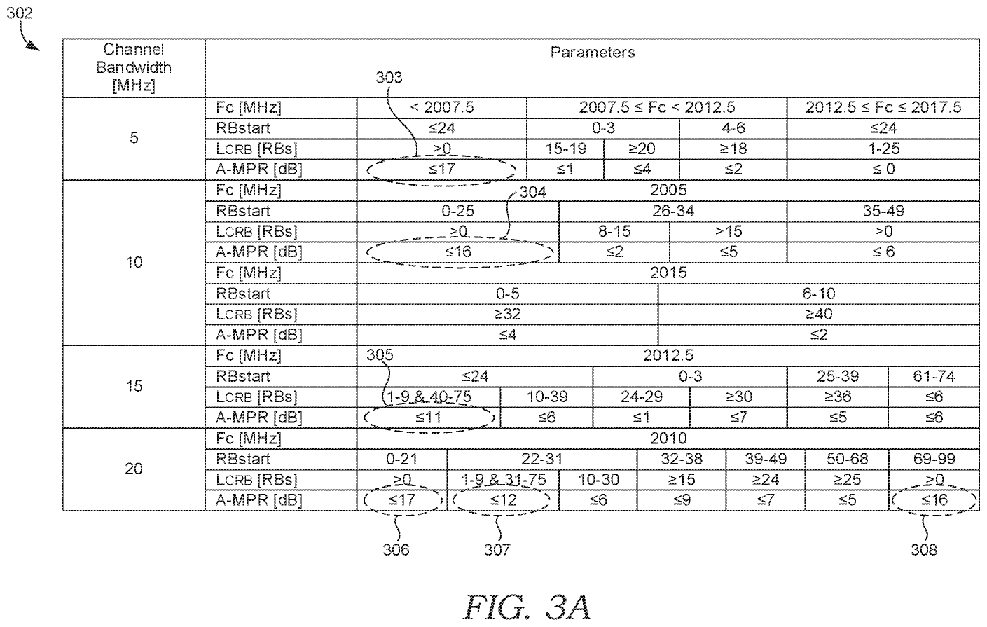

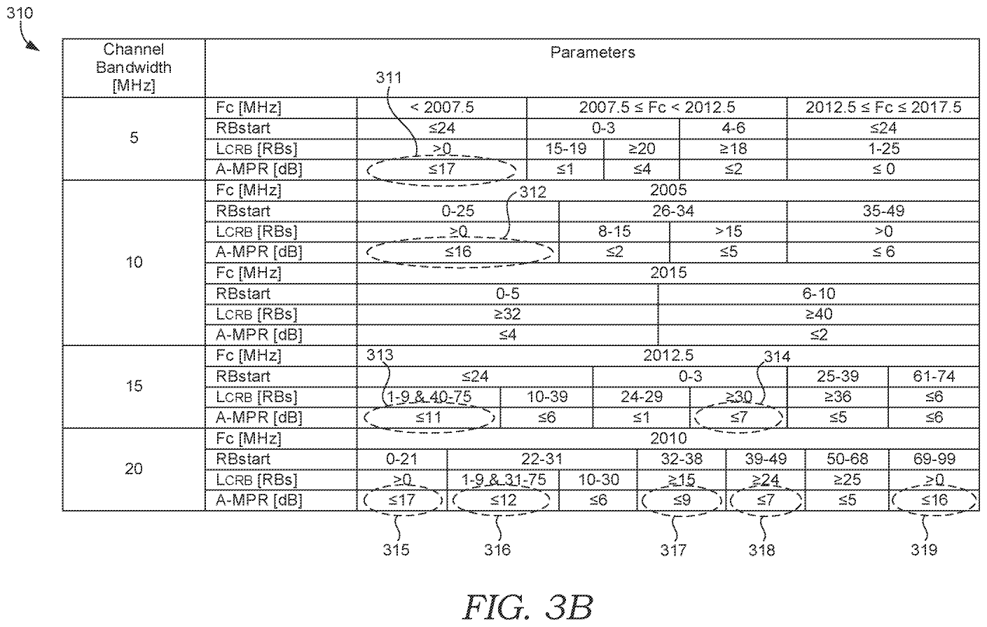

In the first embodiment, a base station will not schedule or assign radio resources to configurations having an A-MPR value greater than a predetermined threshold. Turning now to FIGS. 3A-3B, annotated versions of table 6.2.4-15 from 3GPP TS 36.101 are provided. According to this embodiment, wherein A-MPR tables may continue to exist in standards documents, a serving cell or base station, such as the terrestrial base station 230, the satellite 204, or the gateway 202 of FIG. 2, may not assign a candidate radio resource allocation to the UE 206 based on a determination that the candidate radio resource allocation has an A-MPR value of greater than a threshold amount. A first example is illustrated by table 302 of FIG. 3A, wherein the threshold A-MPR value is 10 dB; candidate radio resource allocations falling within six parameters 303-308 will be barred from being assigned to a UE such as the UE 206 of FIG. 2. In two contrasting hypotheticals using FIG. 3A, a first candidate radio resource allocation would not be assigned to a UE if it had a 5 MHz channel bandwidth centered at 2005 MHz, a starting resource block of less than 24, and any length of contiguous resource blocks (because the associated A-MPR value is up to 17 dB); whereas, a second candidate radio resource allocation could be assigned as normal to a UE if it had a 10 MHz channel bandwidth centered at 2015 MHz, a starting resource block of 6, and greater than 40 contiguous resource blocks in length (because the associated A-MPR value is up to 2 dB). In a second example of the first embodiment, illustrated by table 310 of FIG. 3B, the threshold A-MPR value is 6 dB; therefore, candidate resource allocations meeting parameters 311-319 will be barred from being assigned to a UE such as the UE 206 of FIG. 2. Though only two thresholds are provided herein with respect to a single A-MPR table from TS 36.101, any threshold A-MPR desirable by a standards body or mobile network operator (and for any band or table for any cellular protocol, including 5G in TS 38.101) may be used as the threshold for determining whether a particular radio resource parameter is barred from being assigned to a UE without departing from the present disclosure.

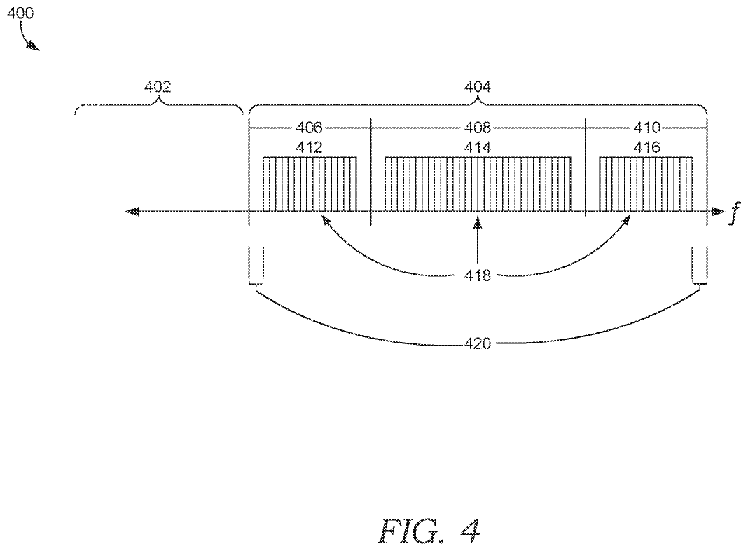

In the second embodiment, the base station will not schedule or assign radio resources to configurations within a predetermined distance of a mobile network operator's allocated spectrum bandwidth edge. Turning now to FIG. 4, a partial band plan is illustrated as spectrum 400. Spectrum 400 comprises a first allocated spectrum bandwidth 402 and a second allocated spectrum bandwidth 404. In some aspects, the first allocated spectrum bandwidth 402 may be owned/leased by a first mobile network operator (MNO) and the second allocated spectrum bandwidth 404 may be owned/leased by a second MNO, wherein the first MNO is different than the second MNO. The present disclosure may be useful to the spectrum 400 in that it may be used to prevent or mitigate spurious transmissions from UEs operating in the second allocated spectrum bandwidth 404 form leeching into the first allocated spectrum bandwidth 402. The second allocated spectrum bandwidth 404 may be divided by the second MNO into three discrete channel bandwidths for the purpose of radio resource allocation: a first channel bandwidth 406, a second channel bandwidth 408, and a third channel bandwidth 410. If, for example, the second allocated spectrum bandwidth 404 is 20 MHz, then the first channel bandwidth 406 may be 5 MHz, the second channel bandwidth 408 may be 10 MHz, and the third channel bandwidth 410 may be 5 MHz. Each of the channel bandwidths may use less than the full bandwidth to actively transmit/receive resource blocks, accounting for guard frequency spacing; the first channel bandwidth 406 comprises the first transmission bandwidth 412, the second channel bandwidth 408 comprises the second transmission bandwidth 414, and the third channel bandwidth 410 comprises the third transmission bandwidth 416. Each of the transmission bandwidths 412, 414, and 416 comprise a plurality of active physical resource blocks 418. According to the second embodiment, a candidate radio resource allocation in the second allocated spectrum bandwidth 404 will be barred from being assigned to a UE such as the UE 206 of FIG. 2 based on a determination that the starting resource block of a candidate radio resource allocation is within a predetermined distance (in frequency) 420 of an edge of the second allocated spectrum bandwidth 404. Though the predetermined distance 420 may be any value determined to be necessary to prevent or mitigate out of band emissions, examples of the predetermined distance 420 are 2.5 MHz, 5 MHz, or 10 MHz. In aspects, the second embodiment may be used to replace A-MPR tables from relevant specifications, by focusing on limiting candidate radio resource allocations having active resource blocks within a predetermined distance of band edges.

In the third embodiment, the base station may initially assign radio resources with a high A-MPR value or within the predetermined threshold distance of the allocated spectrum bandwidth edge; however, the UE may determine and communicate an indication to the base station that is in a state of uplink power limitation, upon which the base station may assign a second radio resource allocation having a smaller A-MPR allowance or further from the allocated spectrum bandwidth edge. A UE may be initially assigned a first radio resource allocation comprising resource blocks within the predetermined distance 420 of an edge of an allocated spectrum bandwidth 404 (FIG. 4) or having a parameter associated with a threshold high A-MPR 303-308 or 311-319 (FIGS. 3A-3B). The UE may attempt to utilize the first radio resource allocation to communicate in the uplink with a RAN; however, if a transmission power required by the UE for such communication results in greater than the threshold limit of out of band/spurious emissions, then the UE will signal to the RAN that it is power constrained. In response to receiving said signaling, the RAN will assign a second radio resource allocation that is further from an edge of the allocated spectrum bandwidth (or having parameters associated with lower A-MPR values); for example, with reference to FIG. 4, if the first radio resource allocation is at least partially disposed in the first transmission bandwidth 412 and the UE signals uplink power constraint, then the second radio resource allocation may be disposed in the second transmission bandwidth 418.

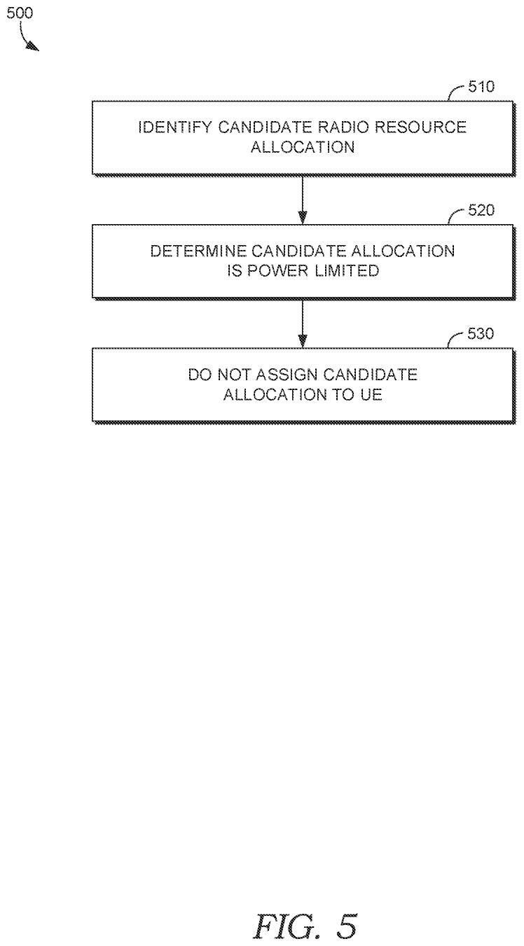

Turning now to FIG. 5, a flow chart representing a method 500 is provided. Generally the method 500 may be used by a base station of a radio access network to allocate radio resources. At a first step 510, a base station or scheduling component identifies a candidate radio resource allocation for a UE to use in an uplink communication session. At a second step 520, it is determined that the candidate radio resource allocation is power limited on the basis that the candidate radio resource allocation has one or more parameters that are associated with a trigger condition, wherein the trigger condition comprises a threshold high A-MPR or a starting/final resource block being with a predetermined threshold frequency distance of an allocated spectrum bandwidth edge, according to any one or more aspects described herein. At a third step 530, the candidate radio resource allocation is not assigned to the UE based on the determination at step 520; instead, a second radio resource allocation not having the trigger condition will be assigned to the UE, according to any one or more aspects described herein.

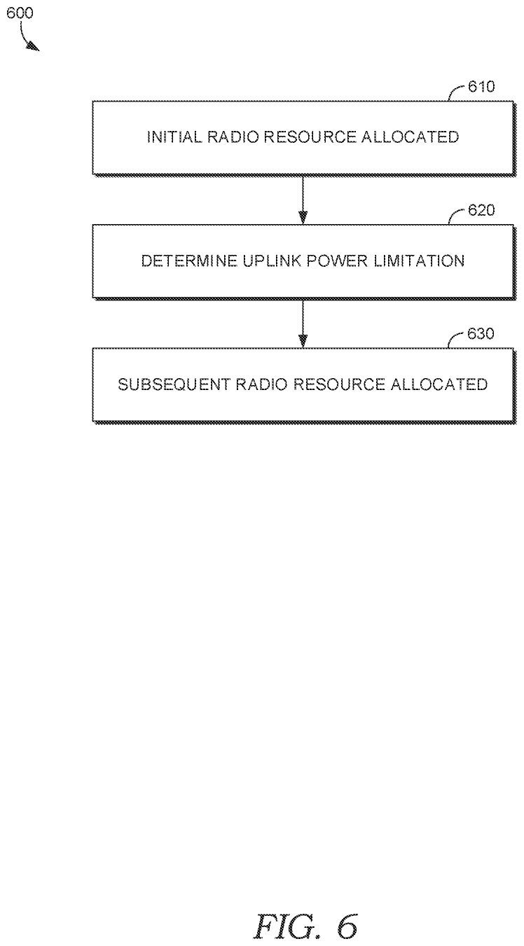

Turning now to FIG. 6, a flow chart representing a method 500 is provided. Generally, the method 600 may be carried out by a UE, such as the UE 206 of FIG. 2, in order to avoid transmitting spurious emissions out of band. At a first step 610, the UE receives a first radio resource allocation from a radio access network, wherein the first radio resource allocation comprises an A-MPR value greater than a predetermined threshold or within a predetermined threshold of an allocated spectrum bandwidth edge, according to any one or more aspects described herein. At a second step 620, the UE attempts to communicate using the first radio resource allocation; the UE may use up to a maximum available transmission power (i.e., maximum power minus MPR and A-MPR), determine that the maximum available transmission power is insufficient for the communication session with the RAN, and communicate an indication of such to the RAN, according to any one or more aspects described herein. At a third step 630, the UE receives a second radio resource allocation, wherein the UE is capable of using a greater maximum available transmission power (e.g., due to a smaller A-MPR value) on the second radio resource allocation, according to any one or more aspects described herein.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for managing uplink transmission power in a wireless telecommunication environment, the system comprising:
a base station configured to wirelessly communicate with a coverage area; and
one or more computer processing components configured to perform operations comprising:
determine a first radio resource allocation is barred based on a determination that one or more trigger conditions are associated with the first radio resource allocation; and
allocating a second radio resource to a UE instead of the first radio resource allocation, the second radio resource allocation comprising an uplink channel bandwidth narrower than a downlink channel bandwidth and being selected based at least in part on a second determination that the one or more trigger conditions are not associated with the second radio resource allocation.

2. The system of claim 1, wherein the base station is a terrestrial radio access network node.

3. The system of claim 2, wherein the one or more trigger conditions comprise one or more key performance indicators associated with a connection between the UE and the base station being below a predetermined threshold.

4. The system of claim 3, wherein the one or more trigger conditions further comprises an additional maximum power reduction value of the first radio resource allocation being greater than a predetermined threshold.

5. The system of claim 3, wherein the one or more trigger conditions further comprises the first radio resource allocation having a starting resource block within a predetermined frequency threshold of an edge of an allocated spectrum bandwidth in which the first radio resource allocation is disposed.

6. The system of claim 5, wherein the one or more trigger conditions further comprise the UE being located within a predetermined threshold distance of a cell edge of coverage area.

7. The system of claim 1, wherein the base station is part of a satellite radio access network, the base station comprising a gateway ground station utilizing a bent pipe satellite as a relay to communicate with the UE or a satellite.

8. The system of claim 7, wherein the one or more trigger conditions comprise the UE being connected to the satellite radio access network.

9. The system of claim 8, wherein the one or more trigger conditions comprise an additional maximum power reduction value of the first radio resource allocation being greater than a predetermined threshold.

10. The system of claim 9, wherein the threshold is 0 dB.

11. The system of claim 9, wherein the threshold is non-zero.

12. The system of claim 8, wherein the one or more trigger conditions further comprises the first radio resource allocation having a starting resource block within a predetermined frequency threshold of an edge of an allocated spectrum bandwidth in which the first radio resource allocation is disposed.

13. The system of claim 8, wherein the one or more trigger conditions further comprises the first radio resource allocation having a final resource block within a predetermined frequency threshold of an edge of an allocated spectrum bandwidth in which the first radio resource allocation is disposed.

14. A method for uplink power control, the method comprising:
receiving a first radio resource allocation from a radio access network (RAN), wherein the first radio resource allocation comprises an additional maximum power reduction (A-MPR) value greater than a predetermined threshold or within a predetermined threshold of an allocated spectrum bandwidth edge;
communicating one or more uplink signals using the first radio resource allocation, wherein the one or more uplink signals are communicated using a transmission power having a spurious emission level less than or equal to a predetermined level, the transmission power being within a range having a lower bound equal to a maximum class-based transmission power minus a maximum power reduction (MPR) value and the A-MPR value associated with the first radio resource allocation and having an upper bound equal to the maximum class-based transmission power;
determining that the transmission power is insufficient for establishing or maintaining a connection with the RAN having one or more key performance indicator values greater than a predetermined threshold; and
receiving a second radio resource allocation, wherein the second radio resource allocation comprises an uplink channel bandwidth narrower than a downlink channel bandwidth and has a smaller A-MPR value than the first radio resource allocation.

15. The method of claim 14, wherein the RAN is a satellite RAN and the second radio resource allocation has a smaller A-MPR value equal to zero dB.

16. A method for radio resource allocation, the method comprising:
identifying a candidate radio resource allocation for a user equipment (UE) to use in an uplink communication session;
determining that the candidate radio resource allocation is power limited on the basis that the candidate radio resource allocation has one or more parameters that are associated with a trigger condition, or a starting/final resource block being with a predetermined threshold frequency distance of an allocated spectrum bandwidth edge;
based on said determination, assigning a second radio resource allocation to the UE instead of the candidate radio resource allocation, the second radio resource allocation comprising an uplink channel bandwidth narrower than a downlink channel bandwidth and not having the one or more parameters that are associated with the trigger condition.

17. The method of claim 16, wherein the trigger condition comprises a threshold high additional maximum power reduction value.

18. The method of claim 16, wherein the trigger condition comprises the uplink communication session being between the UE and a satellite radio access network.

19. The method of claim 18, wherein the trigger condition comprises a starting resource block being with a predetermined threshold frequency distance of an allocated spectrum bandwidth edge.

20. The method of claim 18, wherein the trigger condition comprises a final resource block being with a predetermined threshold frequency distance of an allocated spectrum bandwidth edge.
